(19) United States
(12) Patent Application Publication
(10) Pub. No.: US 2025/0174726 A1
(43) Pub. Date: May 29, 2025

(54) ELECTROLYTIC SOLUTION, LITHIUM-SULFUR SECONDARY BATTERY, AND MODULE

(71) Applicant: DAIKIN INDUSTRIES, LTD., Osaka-shi (JP)

(72) Inventors: Tomoya HIDAKA, Osaka-shi (JP); Yoshiko Kuwajima, Osaka-shi (JP); Shigeaki Yamazaki, Osaka-Shi (JP)

(73) Assignee: DAIKIN INDUSTRIES, LTD., Osaka-shi (JP)

(21) Appl. No.: 19/030,617

(22) Filed: Jan. 17, 2025

Related U.S. Application Data
(63) Continuation of application No. 17/596,113, filed on Dec. 3, 2021.

(30) Foreign Application Priority Data
Jun. 5, 2019 (JP) 2019-105668

(51) Int. Cl. H01M 10/0569; H01M 4/02; H01M 4/38; H01M 4/58; H01M 4/60; H01M 10/052; H01M 10/0568

(52) U.S. Cl. CPC H01M 10/0569; H01M 4/38; H01M 4/58; H01M 4/60; H01M 10/052; H01M 10/0568; H01M 2004/028; H01M 2300/0034

(57) ABSTRACT

A lithium-sulfur secondary battery containing a positive electrode or a negative electrode containing a sulfur-containing electrode active material containing at least one selected from the group consisting of simple sulfur, lithium polysulfides (Li₂Sn: 1≤n≤8) and organosulfur compounds, wherein the lithium-sulfur secondary battery contains an electrolytic solution containing a fluorinated ether and an ether compound, where the fluorinated ether and the ether compound in total is 80% by weight or more of a solvent in the electrolytic solution.

### CROSS REFERENCE TO RELATED APPLICATIONS

This application is a Rule 53 (b) Continuation of U.S. Application No. 17/596, 113 filed Dec. 3, 2021, which is a National Stage of International Application No. PCT/JP2020/022276 filed Jun. 5, 2020, claiming priority based on Japanese Patent Application No. 2019-105668 filed Jun. 5, 2019, the contents of all of which are incorporated herein by reference in their entireties.

### TECHNICAL FIELD

The present invention relates to an electrolytic solution, a lithium-sulfur secondary battery, and a module.

### BACKGROUND ART

As high-capacity secondary batteries, lithium ion secondary batteries are widely used, and as higher-capacity secondary batteries, lithium-sulfur secondary batteries are being studied.

In these various types of batteries, the properties of electrolytic solution largely affect the performance of the batteries.

Patent Literature 1 discloses use of an electrolytic solution containing a specific ether compound and an alkali metal salt wherein at least parts of the ether compound and the alkali metal salt form a complex, in a lithium-sulfur secondary battery.

Patent Literature 2 discloses an electrolytic solution containing an ether, an ionic liquid and a fluorinated solvent.

Patent Literature 3 discloses use of an electrolytic solution containing tetraglyme and an alkali metal salt, in a lithium-sulfur secondary battery.

Patent Literature 4 discloses a lithium-sulfur secondary battery including a positive electrode containing simple sulfur, and a nonaqueous electrolytic solution containing at least one of a cyclic ether and a chain ether and at least one of a fluorinated carbonate and a fluorinated ester.

Non Patent Literature 1 discloses use of ethyl 1,1,2,2-tetrafluoroethyl ether as an electrolytic solution in a lithium/sulfur battery.

### CITATION LIST

### Patent Literature

Patent Literature 1: Japanese Patent Laid-Open No. 2013-225496
Patent Literature 2: Japanese Patent Laid-Open No. 2014-41811
Patent Literature 3: Japanese Patent No. 5804557
Patent Literature 4: Japanese Patent Laid-Open No. 2005-108724

### Non Patent Literature

Non Patent Literature 1: Electrochimica Acta 161 (2015), 55-62

### SUMMARY OF INVENTION

### Technical Problem

The present disclosure aims to provide an electrolytic solution capable of improving the output characteristics and the capacity retention, a lithium-sulfur secondary battery comprising the electrolytic solution, as well as a module.

### Solution to Problem

The present disclosure is an electrolytic solution to be used for a battery having a positive electrode or a negative electrode containing a sulfur-containing electrode active material containing at least one selected from the group consisting of simple sulfur, lithium polysulfides (Li₂Sn: 1≤n≤8) and organosulfur compounds, the electrolytic solution comprising:
a fluorinated ether represented by formula (1):

Rf-(OR¹)ₙ₁—O—R²
wherein Rf is an alkyl group having a fluorine atom and optionally forming a branch or a ring having 1 to 5 carbon atoms; R¹ is an alkyl group optionally having a fluorine atom; R² is an alkyl group having no fluorine atom, having 1 to 9 carbon atoms and optionally forming a branch or a ring; n₁ is 0, 1 or 2; and the number of carbon atoms in one molecule is 5 or more;
an ether compound represented by formula (2):

R⁴—(OCHR³CH₂)ₓ—OR⁵
wherein R⁴ and R⁵ are each independently selected from the group consisting of alkyl groups having 1 to 9 carbon atoms and having no fluorine atom, a phenyl group optionally substituted by a halogen atom and a cyclohexyl group optionally substituted by a halogen atom, and optionally together form a ring; R³ each independently represents H or CH₃; and x represents 0 to 10; and an alkali metal salt.

The fluorinated ether is preferably at least one selected from the group consisting of HCF₂CF₂OCH₂CH₂CH₃, HCF₂CF₂OCH₂CH₂CH₂CH₃, HCF₂CF₂CH₂OCH₂CH₃, HCF₂CF₂CH₂OCH₂CH₂CH₃, HCF₂CF₂CH₂OCH₂CH₂CH₂CH₃, CF₃CHFCF₂OCH₂CH₃ and CF₃CHFCF₂OCH₂CH₂CH₃.

The fluorinated ether represented by the formula (1) and the ether compound represented by the formula (2) in total is preferably 60% by weight or more of a solvent in the electrolytic solution.

The ether compound is preferably at least one selected from the group consisting of tetrahydrofuran (THE), 1,3-dioxolane, 1,4-dioxane, glymes, and derivatives thereof.

The alkali metal salt is represented by LiX; and X is preferably at least one selected from the group consisting of Cl, Br, I, BF₄, PF₆, CF₃SO₃, ClO₄, CF₃CO₂, AsF₆, SbF₆, AlCl₄, bistrifluoromethanesulfonylamide (TFSA), N(CF₃SO₂)₂, N(CF₃CF₂SO₂)₂, PF₃(C₂F₅)₃, N(FSO₂)₂, N(FSO₂) (CF₃SO₂), N(CF₃CF₂SO₂)₂, N(C₂F₄S₂O₄), N(C₃F₆S₂O₄), N(CN)₂, N(CF₃SO₂) (CF₃CO), R⁶FBF₃ wherein R⁶F is n-CₘF₂ₘ₊₁ and m is a natural number of 1 to 4, and R⁷BF₃ wherein R⁷ is n-CₚH₂ₚ₊₁ and p is a natural number of 1 to 5.

The present disclosure is also a lithium-sulfur secondary battery comprising the above-mentioned electrolytic solution.

The lithium-sulfur secondary battery preferably includes a positive electrode containing a sulfur-containing electrode active material.

The present disclosure is also a module comprising the above-mentioned lithium-sulfur secondary battery.

### Advantageous Effects of Invention

The present disclosure enables to provide an electrolytic solution capable of improving the output characteristics and the capacity retention. A lithium-sulfur secondary battery including the electrolytic solution of the present disclosure provides good battery output.

### DESCRIPTION OF EMBODIMENTS

Hereinafter, the present disclosure will be described in detail.

The present disclosure relates to an electrolytic solution to be used in various types of batteries such as lithium-sulfur secondary batteries.

In particular, in lithium-sulfur secondary batteries, it is said that the discharge capacity is lowered by repetition of charge and discharge due to dissolving-out into an electrolytic solution of lithium polysulfide (Li₂Sₙ) generated by the electrode reaction in charge and discharge, making the battery life short. Hence, there has been studied the use of fluorine-containing compounds low in the dissolving capability of lithium polysulfide (Li₂Sₙ) in an electrolytic solution.

In the lithium-sulfur secondary batteries, when the viscosity of an electrolytic solution is made low, it becomes easy for the electrolytic solution to penetrate the innermost of a sulfur-carbon composite electrode, and there is thereby enlarged the interface where the electrode and the electrolytic solution can react electrochemically. It is presumed that hence, the internal resistance of the batteries is reduced and the input/output density in charging and in discharging is improved. In the present disclosure, from these viewpoints, by using a fluorinated ether low in viscosity among fluorine-containing compounds low in the dissolving capability of lithium polysulfide (Li₂Sₙ), the battery performance can be improved.

### Fluorinated Ether

The electrolytic solution of the present disclosure is characterized by comprising a fluorinated ether represented by the following general formula (1):

Rf-(OR¹)ₙ—O—R² (1)
wherein Rf is an alkyl group having a fluorine atom and optionally forming a branch or a ring having 1 to 5 carbon atoms; R¹ is an alkyl group optionally having a fluorine atom; R² is an alkyl group having no fluorine atom, having 1 to 9 carbon atoms and optionally forming a branch or a ring; n is 0, 1 or 2; and the number of carbon atoms in one molecule is 5 or more. The compound is, as compared with various types of fluorine-containing solvents used in lithium sulfur batteries, a compound which can make the viscosity of the electrolytic solution to be low and can improve the battery performance by the above-mentioned action. Further, the use of the compound having 5 or more carbon atoms in one molecule brings about an advantage of exhibiting a boiling point suitable for a practical operation temperature region. The upper limit of the number of carbon atoms is not limited, and the upper limit is preferably 6 since the viscosity rises and the miscibility with a Li salt decreases with increasing molecular weight.

Among the above compounds, in the point of the viscosity, HCF₂CF₂OCH₂CH₂CH₃ and HCF₂CF₂OCH₂CH₂CH₂CH₃ are especially preferable.

Compounds represented by the above formula (1) are not limited, and examples thereof include HCF₂CF₂OCH₂CH₂CH₃, HCF₂CF₂OCH₂CH₂CH₂CH₃, HCF₂CF₂CH₂OCH₂CH₃, HCF₂CF₂CH₂OCH₂CH₂CH₃, HCF₂CF₂CH₂OCH₂CH₂CH₂CH₃, CF₃CHFCF₂OCH₂CH₃ and CF₃CHFCF₂OCH₂CH₂CH₃. Two or more compounds among these compounds may be mixed and used.

The compounds represented by the above (1) are limited to compounds having 5 or more carbon atoms, but alternatively, the compounds may contain, in the range of not impairing the advantageous effects of the present disclosure, a fluorinated ether represented by the above formula (1) and having 4 or less carbon atoms.

Examples of the fluorinated ether having 4 or less carbon atoms include HCF₂CF₂OCH₂CH₃.

The fluorinated ether to be used in the present disclosure is limited to a compound represented by the above (1), but alternatively, the fluorinated ether may contain, in the range of not impairing the advantageous effects of the present disclosure, a fluorinated ether represented by:

Rf1-(OR¹)ₙ₁—O—Rf2 (1-1)
wherein Rf1 and Rf2 are alkyl groups having a fluorine atom, which are identical or different; R¹ is an alkyl group optionally having a fluorine atom; n₁ is 0, 1 or 2; and the number of carbon atoms in one molecule is 5 or more. Examples of the fluorinated ether like (1-1) include HCF₂CF₂CH₂OCF₂CHFCF₃, HCF₂CF₂CH₂OCF₂CF₂H, CF₃CF₂CH₂OCF₂CHFCF₃, CF₃CF₂CH₂OCF₂CF₂H, HCF₂CF₂OC₂H₅, HCF₂CF₂OC₂H₅OCF₂CF₂H and CF₃OC₂H₅OCF₃.

It is preferable that the above fluorinated ether is contained in a proportion of 0.1 to 90% by weight in the electrolytic solution. With the proportion in this range, the electrolytic solution can be used as a good electrolytic solution. The lower limit thereof is more preferably 5% by weight and still more preferably 10% by weight. The upper limit thereof is more preferably 80% by weight and still more preferably 60% by weight.

### Ether Compound

The electrolytic solution of the present disclosure comprises a specific ether compound not corresponding to the above-mentioned fluorinated ether. With regard to that the formation of a complex of the ether compound with an alkali metal salt provides the electrochemical stability, resulting in improving the battery performance, some prior literatures disclose the improvement.

Also in the present disclosure, the electrolytic solution containing the ether compound not corresponding to the above-mentioned fluorinated ether can attain such an effect.

The ether compound is represented by the following general formula (2):

R⁴—(OCHR³CH₂)ₓ—OR⁵ (2)
wherein R⁴ and R⁵ are each independently selected from the group consisting of alkyl groups having 1 to 9 carbon atoms and having no fluorine atom, a phenyl group optionally substituted by a halogen atom and a cyclohexyl group optionally substituted by a halogen atom, and optionally together form a ring; R³ each independently represent H or CH₃; and x represents 0 to 10. Note that the ether compound used here is limited to one not corresponding to a compound represented by the above-mentioned formula (1).

The alkyl group in the above formula includes a methyl group, an ethyl group, a propyl group, an isopropyl group, a butyl group, an isobutyl group, a pentyl group, an isopentyl group, a hexyl group, a heptyl group, an octyl group and a nonyl group. When the number of carbon atoms of the alkyl group exceeds 9, since the polarity of the ether compound becomes weak, the dissolvability of an alkali metal salt is likely to lower. Hence, it is preferable that the number of carbon atoms of the alkyl group is low; and preferable are a methyl group and an ethyl group, and most preferable is a methyl group.

The phenyl group optionally substituted by a halogen atom is not limited, and includes a 2-chlorophenyl group, a 3-chlorophenyl group, a 4-chlorophenyl group, a 2,4-dichlorophenyl group, a 2-bromophenyl group, a 3-bromophenyl group, a 4-bromophenyl group, a 2,4-dibromophenyl group, a 2-iodophenyl group, a 3-iodophenyl group, a 4-iodophenyl group and a 2,4-iodophenyl group.

The cyclohexyl group optionally substituted by a halogen atom is not limited, includes a 2-chlorocyclohexyl group, a 3-chlorocyclohexyl group, a 4-chlorocyclohexyl group, a 2,4-dichlorocyclohexyl group, a 2-bromocyclohexyl group, a 3-bromocyclohexyl group, a 4-bromocyclohexyl group, a 2,4-dibromocyclohexyl group, a 2-iodocyclohexyl group, a 3-iodocyclohexyl group, a 4-iodocyclohexyl group and a 2,4-diiodocyclohexyl group.

R³ represents H or CH₃, and in the case where x is 2 or more, are independent of each other.
x represents 0 to 10, and represents the repeating number of an ethylene oxide unit. x is preferably 1 to 6, more preferably 2 to 5 and most preferably 3 or 4.

Examples of the ether compound include tetrahydrofuran (THF), 1,3-dioxolane, 1,4-dioxane, glymes, and derivatives thereof.

The ether compounds represented by the above general formula may together form a ring, and this ring compound includes, in the case where x is 0, tetrahydrofuran (THF) and a derivative thereof, 2-methyltetrahydrofuran, and in the case where x is 1,1,3-dioxolane and 1,4-dioxane.

The glymes are represented by the above general formula (2) (provided that R³ represents H, x represents 1 or more, and the glymes are linear compounds), and include monoglyme (G1, x=1), diglyme (G2, x=2), triglyme (G3, x=3) and tetraglyme (G4, x=4). The monoglyme (G1) include methylmonoglyme and ethylmonoglyme; and the diglyme (G2) include ethyldiglyme and butyldiglyme.

The use of a glyme in which x is 1 to 10 as the ether compound can further improve the thermal stability, the ionic conductivity and the electrochemical stability of the electrolytic solution and can make the electrolytic solution capable of withstanding high voltages.

The ether compound to be used for the electrolytic solution may be used singly in one kind, or may be used in a mixture form of two or more kinds.

It is preferable that the ether compound is contained in a proportion of 5 to 90% by weight in the electrolytic solution. With the proportion in this range, the electrolytic solution can be used as a good electrolytic solution. The lower limit thereof is more preferably 10% by weight and still more preferably 20% by weight. The upper limit thereof is more preferably 80% by weight and still more preferably 60% by weight.

Then, in view of excellent capacity retention, it is preferable that the fluorinated ether represented by the formula (1) and the ether compound represented by the formula (2) in total is 80% by weight or more with respect to the total amount of the electrolytic solution.

Further it is preferable that the amount of carbonates is less than 20% by weight with respect to the total amount of the electrolytic solution.

### Alkali Metal Salt

The electrolytic solution of the present disclosure comprises an alkali metal salt.

The alkali metal salt can be represented by MX, and is a substance in which M is an alkali metal and X is an anion of the ion pair. The alkali metal salt may be used singly in one kind, or may be used in a mixture form of two or more kinds.

It is especially preferable that the alkali metal salt is a lithium salt (that is, a compound represented by LiX).

X is not limited, and preferable is at least one selected from the group consisting of Cl, Br, I, BF₄, PF₆, CF₃SO₃, ClO₄, CF₃CO₂, AsF₆, SbF₆, AlCl₄, bistrifluoromethanesulfonylamide (TFSA), N(CF₃SO₂)₂, N(CF₃CF₂SO₂)₂, PF₃(C₂F₅)₃, N(FSO₂)₂, N(FSO₂) (CF₃SO₂), N(CF₃CF₂SO₂)₂, N(C₂F₄S₂O₄), N(C₃F₆S₂O₄), N(CN)₂, N(CF₃SO₂) (CF₃CO), R₄FBF₃ (wherein R₄F is n-CₘF₂ₘ₊₁, where m is a natural number of 1 to 4 and n stands for normal) and R₅BF₃ (wherein R₅ is n-CₚH₂ₚ₊₁, where p is a natural number of 1 to 5 and n stands for normal). In the point of the dissolvability to the ether compound and the ease of formation of a complex structure, more preferable are N(CF₃SO₂)₂, N(CF₃CF₂SO₂)₂, TESA and PF₆.

It is preferable that the alkali metal salt is contained in a proportion of 3.0 to 30% by weight in the electrolytic solution. With the proportion in this range, the electrolytic solution can be used as a good electrolytic solution. The lower limit thereof is more preferably 5.0% by weight and still more preferably 8.0% by weight. The upper limit thereof is more preferably 20% by weight and still more preferably 15% by weight.

Then in the electrolytic solution of the present disclosure, it is preferable that the mixing ratio ((fluorinated ether)/(alkali metal salt)) of the fluorinated ether and the alkali metal salt has a lower limit of 0.1 and an upper limit of 5.0 (in terms of molar ratio). When the mixing ratio is in this range, since the coordination of the fluorinated ether to the alkali metal ion is good, the case is preferable. It is more preferable that the mixing ratio has a lower limit of 0.5 and an upper limit of 4.0.

Then, in the electrolytic solution of the present disclosure, it is preferable that the mixing ratio ((alkali metal salt)/(ether compound)) of the ether compound and the alkali metal salt has a lower limit of 0.1 and an upper limit of 3.0 (in terms of molar ratio). When the mixing ratio is in this range, since the electrochemical stability is especially good, the case is preferable. It is more preferable that the mixing ratio has a lower limit of 0.5 and an upper limit of 1.0.

### Other Components

Alternatively, the electrolytic solution of the present disclosure, as required, may concurrently use other components, in addition to the above-mentioned fluorinated ether, ether compound and alkali metal salt.

It is preferable that the electrolytic solution contains at least one selected from the group consisting of fluorinated saturated cyclic carbonates, fluorinated chain carbonates and fluorinated esters, because their use makes the cycle performance further excellent and further lowers the overvoltage.

It is preferable that the at least one selected from the group consisting of fluorinated saturated cyclic carbonates, fluorinated chain carbonates and fluorinated esters is contained in 0.01 to 10% by weight with respect to the electrolytic solution. The content is more preferably 0.5% by weight or more, and more preferably 3.0% by weight or less. In the case where two or more kinds thereof are contained, it is preferable that the total amount falls within the above range.

As the fluorinated saturated cyclic carbonates, preferable are ones represented by the formula (3):

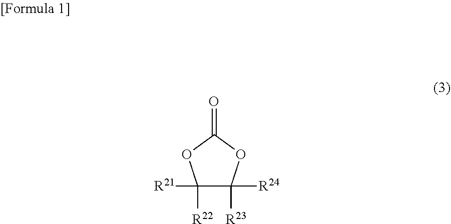

wherein R²¹ to R²⁴ are identical or different and each represent —H, —CH₃, —F, a fluorinated alkyl group optionally having an ether bond, or a fluorinated alkoxy group optionally having an ether bond; provided that at least one of R²¹ to R²⁴ is —F, a fluorinated alkyl group optionally having an ether bond, or a fluorinated alkoxy group optionally having an ether bond.

The fluorinated alkyl group is preferably one having 1 to 10 carbon atoms, more preferably one having 1 to 6 carbon atoms and still more preferably one having 1 to 4 carbon atoms.

The fluorinated alkyl group may be linear or branched chain.

The fluorinated alkoxy group is preferably one having 1 to 10 carbon atoms, more preferably one having 1 to 6 carbon atoms and still more preferably one having 1 to 4 carbon atoms.

The fluorinated alkoxy group may be linear or branched chain.

R²¹ to R²⁴ are identical or different and are preferably each at least one selected from the group consisting of —H, —CH₃, —F, —CF₃, —C₄F₉, —CHF₂, —CH₂F, —CH₂CF₂CF₃, —CH₂—CF(CF₃)₂, —CH₂—O—CH₂CHF₂CF₂H, —CH₂CF₃ and —CF₂CF₃.

In this case, at least one of R²¹ to R²⁴ is at least one selected from the group consisting of —F, —CF₃, —C₄F₉, —CHF₂, —CH₂F, —CH₂CF₂CF₃, —CH₂—CF(CF₃)₂, —CH₂—O—CH₂CHF₂F₂H, —CH₂CF₃ and —CF₂CF₃.

The fluorinated saturated cyclic carbonate is preferably at least one selected from the group consisting of the following compounds.

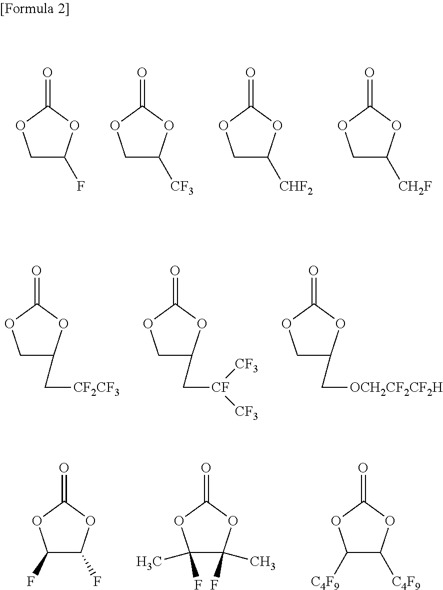

As the fluorinated chain carbonates, preferable are ones represented by the formula (4):

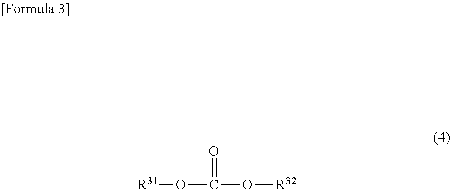

wherein R³¹ and R³² are identical or different and each represent an alkyl group optionally having an ether bond and optionally having a fluorine atom; provided that either one of R³¹ and R³² has a fluorine atom.

The alkyl group is preferably one having 1 to 10 carbon atoms, more preferably one having 1 to 6 carbon atoms and still more preferably one having 1 to 4 carbon atoms.

The alkyl group may be linear or branched chain.

R³¹ and R³² are identical or different and are preferably each at least one selected from the group consisting of —CH₃, —CF₃, —CHF₂, and —CH₂F, —C₂H₅, —CH₂CF₃, —CH₂CHF₂ and —CH₂CF₂CF₂H.

In this case, at least one of R³¹ and R³² is at least one selected from the group consisting of —CF₃, —CHF₂, —CH₂F, —CH₂CHF₂, —CH₂CF₃ and —CH₂CF₂CF₂H.

The fluorinated chain carbonate is preferably at least one selected from the group consisting of the following compounds.

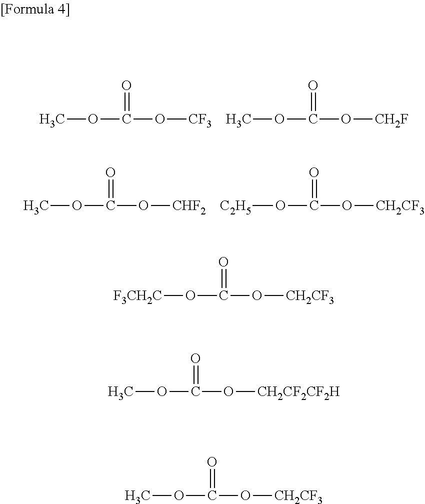

As the fluorinated esters, preferable are ones represented by the formula (5):

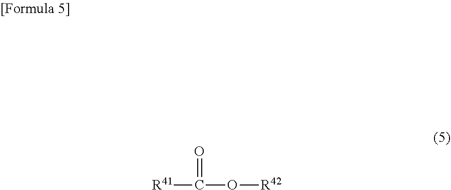

wherein R⁴¹ and R⁴² are identical or different and each represent an alkyl group optionally having an ether bond and optionally having a fluorine atom, and are optionally bonded to each other to form a ring; provided that either one of R⁴¹ and R⁴² has a fluorine atom.

The alkyl group is preferably one having 1 to 10 carbon atoms, more preferably one having 1 to 6 carbon atoms and still more preferably one having 1 to 4 carbon atoms.

The alkyl group may be linear or branched chain.

R⁴¹ and R⁴² are identical or different and are preferably each at least one selected from the group consisting of —CH₃, —C₂H₅, —CHF₂, —CH₂F, —CH(CF₃)₂, —CHFCF₃, —CF₃ and —CH₂CF₃.

In this case, at least one of R⁴¹ and R⁴² is at least one selected from the group consisting of —CHF₂, —CH(CF₃)₂, —CHFCF₃, —CF₃ and —CH₂CF₃.

R⁴¹ and R⁴² being bonded to each other to form a ring means that R⁴¹ and R⁴² together form the ring with a carbon atom and an oxygen atom to which R⁴¹ and R⁴² are bonded, respectively, and R⁴¹ and R⁴² constitute a part of the ring as fluorinated alkylene groups. In the case where R⁴¹ and R⁴² are bonded to each other to form the ring, R⁴¹ and R⁴² are preferably each at least one selected from the group consisting of —CH₂CH₂CH(CH₂CF₃)—, —CH(CF₃)CH₂CH₂—, —CHFCH₂CH₂—, —CH₂CH₂CHF— and —CH₂CH₂CH(CF₃)—.

The fluorinated ester is preferably at least one selected from the group consisting of the following compounds.

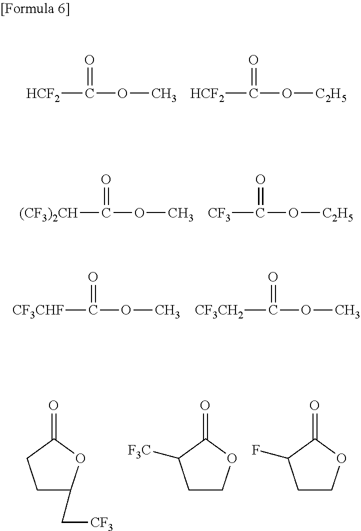

Alternatively, the electrolytic solution of the present disclosure may further contain a cyclic borate ester. The electrolytic solution containing the cyclic borate ester can have a better capacity retention.

The cyclic borate ester is not limited, and is preferably, for example, at least one selected from the group consisting of the following compounds.

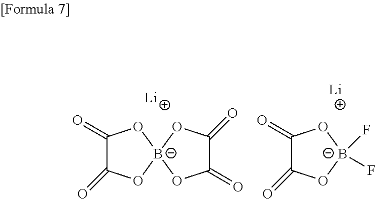 [SMILES: [Li+] ; [Li+] ; O=C1O[B-]2(OC1=O)OC(=O)C(=O)O2 ; O=C1O[B-](F)(F)OC1=O]

It is preferable that the electrolytic solution of the present disclosure contains the above-mentioned cyclic borate ester preferably in 0.01% by weight or more and more preferably in 1.0% by weight or more. The upper limit is not limited, and is preferably 1.0% by weight.

Alternatively, the electrolytic solution may be a nonaqueous electrolytic solution.

Further, the electrolytic solution of the present disclosure may be a gel electrolytic solution which is gelatinous. The gel electrolytic solution has a constitution configured by injecting an electrolytic solution in a matrix polymer composed of an ion-conductive polymer. As this electrolytic solution, the above-mentioned electrolytic solution of the present disclosure is used. Examples of the ion-conductive polymer to be used as the matrix polymer include polyethylene oxide (PEO), polypropylene oxide (PPO), polyethylene glycol (PEG), polyacrylonitrile (PAN), copolymers of vinylidene fluoride-hexafluoropropylene (VDF-HEP), polymethyl methacrylates (PMMA), and copolymers thereof. Electrolytic solution salts such as lithium salts can well be dissolved in polyalkylene oxide-based polymers.

### Battery

The electrolytic solution of the present disclosure, though being capable of being used as an electrolytic solution in various types, regardless of kinds, of batteries, can suitably be used particularly for a battery having a positive electrode or a negative electrode containing a sulfur-containing electrode active material containing at least one selected from the group consisting of simple sulfur, lithium polysulfides (Li₂Sn: 1≤n≤8) and organosulfur compounds. Such a battery corresponds to a battery generally called a lithium-sulfur secondary battery. The above battery including the above-mentioned electrolytic solution as an electrolytic solution is also one aspect of the present disclosure. Hereinafter, such a battery will be described in detail.

A lithium-sulfur secondary battery of the present disclosure has a positive electrode or a negative electrode having a sulfur-containing electrode active material, the above-mentioned electrolytic solution of the present disclosure, and a counter electrode of the positive electrode or the negative electrode.

The alkali metal-sulfur-containing secondary battery involved in the present disclosure can be configured, for example, to have such a structure that: the above positive electrode or negative electrode and the counter electrode are disposed separately from each other through a separator; the electrolytic solution is made to be contained in the separator to constitute a cell; and a plurality of the cells are laminated or the cell is wound and housed in a case. Current collectors of the positive electrode or negative electrode and the counter electrode are led outside the case, and electrically connected to tabs (terminals), respectively. As the electrolytic solution, alternatively, the gel electrolytic solution may be used.

### Positive Electrode or Negative Electrode Having a Sulfur-Containing Electrode Active Material

The positive electrode or negative electrode has a sulfur-containing electrode active material containing at least one selected from the group consisting of simple sulfur, lithium polysulfides (Li₂Sn: 1≤n≤8) and organosulfur compounds. The organosulfur compounds include organic disulfide compounds and carbon sulfide compounds.

The positive electrode or negative electrode, in addition to the above-mentioned sulfur-containing electrode active material, may contain a binder and a conductive agent. Then, a slurry (paste) of these electrode materials is applied and dried on a conductive carrier (current collector) to make the electrode materials to be carried on the carrier, whereby the positive electrode or negative electrode can be produced. The current collector includes conductive metals, such as aluminum, nickel, copper or stainless steel, formed into a foil, a mesh, an expanded grid (expanded metal), a punched metal or the like. Alternatively, a resin having conductivity or a resin containing a conductive filler may be used as the current collector. The thickness of the current collector is, for example, 5 to 30 μm, but is not limited in this range.

The content of the sulfur-containing electrode active material in the above electrode materials (the total amount of the sulfur-containing electrode active material and the other components, excluding the current collector) is preferably 50 to 98% by weight and more preferably 80 to 98% by weight. When the content of the active material is in the above range, since the energy density can be raised, the case is suitable.

The thickness of the electrode materials (thickness of one layer of applied layers) is preferably 10 to 500 μm, more preferably 20 to 300 μm and still more preferably 20 to 150 μm.

As the binder, there can be used polyethylene (PE), polypropylene (PP), polyethylene terephthalate (PET), polyether nitrile (PEN), polyimide (PI), polyamide (PA), polytetrafluoroethylene (PTFE), styrene-butadiene rubber (SBR), polyacrylonitrile (PAN), polymethyl acrylate (PMA), polymethyl methacrylate (PMMA), polyvinyl chloride (PVC), polyvinylidene fluoride (PVDF), polyvinyl alcohol (PVA), polyacrylic acid (PAA), lithium polyacrylate (PAALi), polyalkylene oxide such as a ring-opened polymer of ethylene oxide or a monosubstituted epoxide, or a mixture or the like of these.

The conductive agent is an additive that is added in order to improve the conductivity, and there can be used graphite, carbon powder such as Ketjen black, inverse opal carbon or acetylene black, carbon fibers such as vapor-grown carbon fibers (VGCF) or carbon nanotubes (CNT), or the like. Alternatively, the electrode materials may contain a supporting salt (a component contained in an electrolytic solution described below).

### Counter Electrode

In the case where the positive electrode has the above-mentioned sulfur-containing electrode active material, the negative electrode to become a counter electrode thereof contains one or two or more negative electrode active materials selected from the group consisting of lithium, sodium, lithium alloys, sodium alloys and composites of lithium/inactive sulfur. The negative electrode active material contained in the negative electrode acts so as to occlude and release alkali metal ions. The negative electrode active material is preferably at least one selected from the group consisting of lithium, sodium, carbon, silicon, aluminum, tin, antimony and magnesium.

More specifically, as the negative electrode active material, there can be used conventionally well-known negative electrode materials including metal materials, such as lithium titanate, lithium metal, sodium metal, lithium aluminum alloys, sodium aluminum alloys, lithium tin alloys, sodium tin alloys, lithium silicon alloys, sodium silicon alloys, lithium antimony alloys and sodium antimony alloys, and carbon materials of crystalline carbon materials, noncrystalline carbon materials or the like, such as natural graphite, artificial graphite, carbon black, acetylene black, graphite, activated carbon, carbon fibers, coke, soft carbon and hard carbon. Among these, it is desirable to use a carbon material or lithium or a lithium transition metal composite oxide, because these can constitute a battery excellent in the input/output characteristics. As the case may be, alternatively, two or more negative electrode active materials may concurrently be used.

In the case where the negative electrode has the above sulfur-containing electrode active material, as the positive electrode to become a counter electrode thereof, there can be used ones containing a positive electrode active material which occludes and releasing alkali metal ions. The positive electrode active material is preferably a lithium transition metal composite oxide, and examples thereof include Li—Mn-based composite oxides such as LiMn₂O₄ and Li—Ni-based composite oxides such as LiNiO₂. The positive electrode active material more specifically preferably includes LiMn₂O₄, LiCoO₂, LiNiO₂, LiFePO₄, LiMnPO₄, LiCo_{0.5}Ni_{0.5}O₂ and LiNi_{0.7}Co_{0.2}Mn_{0.1}O₂. Further, materials other than lithium can be used without limitations as long as being substances which electrochemically intercalate and release alkali metal ions, and examples thereof include sodium. Alternatively, two or more positive electrode active materials may concurrently be used.

The counter electrode also may contain the above-mentioned active material, binder and conductive agent. Then, these electrode materials are made to be carried on a conductive carrier (current collector), whereby the counter electrode can be produced. As the current collector, the same one as in the above can be used.

Between the positive electrode and the negative electrode, a separator is usually disposed. Examples of the separator include a glass fiber-made separator, and a porous sheet and a nonwoven fabric composed of a polymer, which absorb and hold an electrolytic solution described later. The porous sheet is constituted, for example, of a microporous polymer. Examples of the polymer constituting such a porous sheet include polyolefin such as polyethylene (PE) and polypropylene (PP), laminates having a three-layer structure of PP/PE/PP, polyimide and aramid. In particular, the polyolefin microporous separator and the glass fiber-made separator are preferable because having a property of being chemically stable to an organic solvent and being able to suppress the reactivity with the electrolytic solution low. The thickness of the separator composed of the porous sheet is not limited, and is, in applications to secondary batteries for driving vehicular motors, preferably 4 to 60 μm as the total thickness of a single layer or a multiple layer. Then, it is preferable that the diameter of micropores of the separator composed of the porous sheet is 10 μm or less at the largest (usually, about 10 to 100 nm), and the porosity is 20 to 80%.

As the nonwoven fabric, there is used, singly or as a mixture, conventionally well-known ones of cotton, rayon, acetate, nylon (R), polyester, polyolefin such as PP and PE, polyimide, aramid and the like. The porosity of the nonwoven fabric separator is preferably 50 to 90%. Further, the thickness of the nonwoven fabric is preferably 5 to 200 μm and especially preferably 10 to 100 μm. When the thickness is smaller than 5 μm, the retention of the electrolytic solution worsens; and in the case of exceeding 200 μm, the resistance increases in some cases.

A module having the above lithium-sulfur secondary battery is one aspect of the present disclosure.

### EXAMPLES

Hereinafter, the present disclosure will be described specifically based on Examples. In the following Examples, unless otherwise specified, “parts” and “%” represent “parts by weight” and “% by weight”, respectively.

Ether compounds G used were the following compounds (G-1) to (G-4).

CH₃—O—CH₂—CH₂—O—CH₃ (G-1)

CH₃—O—CH₂—CH₂—O—CH₂—CH₂—O—CH₃ (G-2)

CH₃—O—CH₂—CH₂—O—CH₂—CH₂—O—CH₂—CH₂—O—CH₃ (G-3)

CH₃—O—CH₂—CH₂—O—CH₂—CH₂—O—CH₂—CH₂—O—CH₂—CH₂—O—CH₃ (G-4)

Then, an alkali metal salt used was lithium bis(trifluoromethanesulfonyl)amide (LiTFSA) or lithium hexafluorophosphate LiPF₆.

A compound G and an alkali metal salt were mixed in a mixing ratio, (alkali metal salt)/(compound G)=0.5, 1.0, 1.5 (in terms of molar ratio) in a glove box in an argon atmosphere. Further to the mixture, a compound I (the following formula) as a fluorinated ether was added in a predetermined proportion, thereby an electrolytic solution was prepared. Here, the mixing ratio of (compound I)/(alkali metal salt) was varied to 0.5, 1.0, 2.0 and 4.0 (in terms of molar ratio).

Compounds I (Fluorinated Ethers)

HCF₂CF₂OCH₂CH₃ (I-1)

HCF₂CF₂OCH₂CH₂CH₃ (I-2)

HCF₂CF₂OCH₂CH₂CH₂CH₃ (I-3)

HCF₂CF₂CH₂₀CF₂CF₂H (I-4)

As other components, the following compound a to e was added in a predetermined amount indicated in Tables 1 to 4.

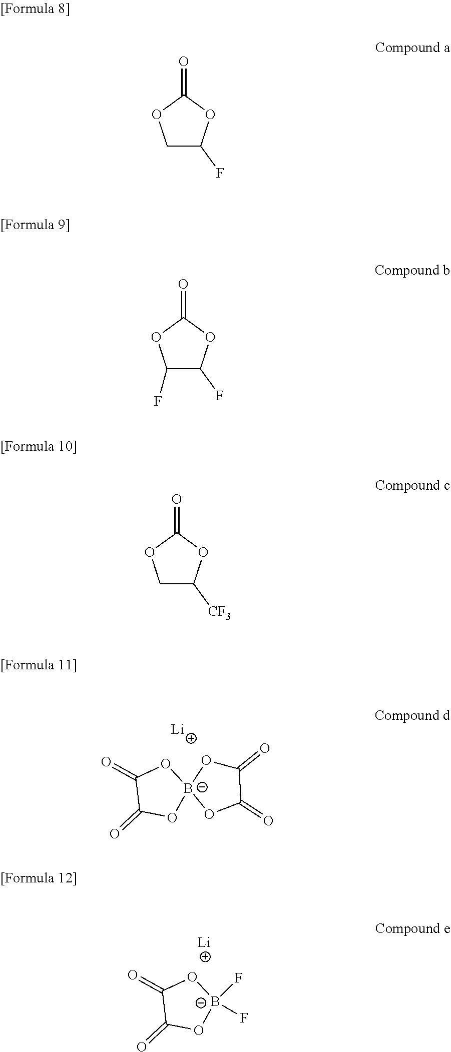

### Preparation of Lithium-Sulfur Batteries

There was prepared a positive electrode mixture slurry made by mixing a carbon composite material containing 40% by weight of sulfur as a positive electrode active material, a carbon black as a conductive material, a carboxymethyl cellulose (CMC) dispersed with pure water, and a styrene-butadiene rubber so that the solid content ratio thereof became 90/5/3/3 (ratio in % by weight). The obtained positive electrode mixture slurry was applied uniformly on an aluminum foil current collector of 20 um in thickness, dried and thereafter compression molded by a press machine to thereby make a positive electrode. The positive electrode laminate was punched out into a size of a diameter of 1.6 cm by a punching machine to thereby prepare a circular positive electrode.

Separately, a negative electrode used was a circular lithium foil punched out into a size of a diameter of 1.6 cm.

The positive electrode and the negative electrode were faced to each other through a 20-μm thick microporous polyethylene film (separator); a nonaqueous electrolytic solution obtained in the above was injected; after the electrolytic solution sufficiently permeated in the separator and other components, the resultant cell was sealed, precharged and aged to thereby prepare coin-type alkali metal-sulfur-containing secondary batteries.

### Cycle Test

The secondary batteries produced in the above, after being each previously discharged at 25° C. at a constant current equivalent to 0.05 C to 1.0 V, were each charged at a constant current equivalent to 0.05 C up to 3.0 V, and thereafter discharged at a constant current equivalent to 0.05 C down to 1.0 V; this cycle was taken as one cycle; and the initial discharge capacity was determined from the discharge capacity of the first cycle. Here, 1C represents a current value at which the reference capacity of a battery is discharged in one hour; for example, 0.05 C represents a current value of 1/20 of that equivalent to 1C. The cycle was repeated and the discharge capacity after 100 cycles was taken as a capacity after the cycles. The proportion of the discharge capacity after 100 cycles to the initial discharge capacity was determined and was taken as a cycle capacity retention (%).

Cycle capacity retention (%)=(a discharge capacity after 100 cycles)/(an initial discharge capacity)×100

### Evaluation of the Output Characteristics

After the 5th cycle mentioned above, the secondary batteries were charged at a constant current of 0.05 C until 3.0 V, and thereafter discharged at a constant current of 0.5 C until 1.0 V to determine the discharge capacity; and was compared to the discharge capacity at 0.05 C in the first cycle. The ratio was taken as the output characteristics (%).

$$Output characteristics ( \% ) = ( a discharge capacity at 0.5 C ) / ( a discharge capacity at 0.05 C ) \times 100$$

TABLE 1

| | Example | Example | Example | Example | Example | Example | Example |
|---|---|---|---|---|---|---|---|
| | 1 | 2 | 3 | 4 | 5 | 6 | 7 |
| Alkali metal salt/ | G-4 | G-4 | G-4 | G-3 | G-3 | G-3 | G-3 |
| Compound G | 0.5 | 1.0 | 1.5 | 1.0 | 1.0 | 1.0 | 1.0 |
| Compound (I)/ | I-2 | I-2 | I-2 | I-2 | I-3 | I-3 | I-3 |
| Alkali metal salt | 0.5 | 0.5 | 0.5 | 0.5 | 0.5 | 1.0 | 1.5 |
| Other components | | | | | | | |
| Alkali metal salt | LiTFSA | LiTFSA | LiTFSA | LiTFSA | LiTFSA | LiTFSA | LiTFSA |
| Capacity retention (%) | 82 | 80 | 81 | 80 | 84 | 85 | 87 |
| Output | 71 | 70 | 67 | 66 | 77 | 78 | 81 |
| characteristics (%) | | | | | | | |

TABLE 2

| | Example | Example | Example | Example | Example | Example | Example |
|---|---|---|---|---|---|---|---|
| | 8 | 9 | 10 | 11 | 12 | 13 | 14 |
| Alkali metal | G-3 | G-3 | G-3 | G-3 | G-3 | G-3 | G-3 |
| salt/ | 1.0 | 1.0 | 1.0 | 1.0 | 1.0 | 1.0 | 1.0 |
| Compound G | | | | | | | |
| Compound | I-3 | I-3 | I-3 | I-3 | I-3 | I-3 | I-3 |
| (I)/Alkali | 2.0 | 4.0 | 4.0 | 2.0 | 2.0 | 2.0 | 2.0 |
| metal salt | | | | | | | |
| Other | | | | Compound | Compound | Compound | Compound |
| components | | | | a 3.0 | b 3.0 | b 10 | b 18 |
| Alkali metal | LiTFSA | LiTFSA | LiPF6 | LiTFSA | LiTFSA | LiTFSA | LiTFSA |
| salt | | | | | | | |
| Capacity | 88 | 83 | 71 | 90 | 91 | 92 | 90 |
| retention (%) | | | | | | | |
| Output | 83 | 85 | 88 | 81 | 82 | 83 | 84 |
| characteristics | | | | | | | |
| (%) | | | | | | | |

TABLE 3

| | Example | Example | Example | Example | Example | Example |
|---|---|---|---|---|---|---|
| | 15 | 16 | 17 | 18 | 19 | 20 |
| Alkali metal salt/ | G-3 | G-3 | G-3 | G-3 | G-1 | G-2 |
| Compound G | 1.0 | 1.0 | 1.0 | 1.0 | 1.0 | 1.0 |
| Compound (I)/ | I-3 | I-3 | I-3 | I-3 | I-3 | I-3 |
| Alkali metal salt | 2.0 | 2.0 | 2.0 | 2.0 | 4.0 | 4.0 |
| | | | | I-4 | | |
| | | | | 0.1 | | |
| Other components | Compound | Compound | Compound | | | |
| | c 3.0 | d 1.0 | e 1.0 | | | |
| Alkali metal salt | LiTFSA | LiTFSA | LiTFSA | LiTFSA | LiTFSA | LiTFSA |
| Capacity retention (%) | 92 | 93 | 93 | 86 | 68 | 70 |
| Output | 80 | 84 | 85 | 81 | 58 | 63 |
| characteristics (%) | | | | | | |

TABLE 4

| | Comparative | Comparative | Comparative | Comparative | Comparative |
|---|---|---|---|---|---|
| | Example 1 | Example 2 | Example 3 | Example 4 | Example 5 |
| Alkali | G-4 | G-4 | G-3 | G-3 | G-3 |
| metal salt/ | 1.0 | 1.0 | 1.0 | 1.0 | 1.0 |
| Compound G | | | | | |
| Compound | I-1 | I-4 | I-1 | I-4 | I-1 |
| (I)/Alkali | 0.5 | 0.5 | 0.5 | 4.0 | 2.0 |
| metal salt | | | | | |
| Other | | | | | Compound |
| components | | | | | d 1.0 |
| Alkali | LiTFSA | LiTFSA | LiTFSA | LiPF6 | LiTFSA |
| metal salt | | | | | |
| Capacity | 34 | 57 | 37 | 31 | 31 |
| retention | | | | | |
| (%) | | | | | |
| Output | 41 | 7 | 36 | 41 | 40 |
| characteristics | | | | | |
| (%) | | | | | |

The results of Tables 1 to 4 make clear that the lithium-sulfur secondary batteries of the Examples using the electrolytic solution of the present disclosure exhibits excellent life characteristics, due to high discharge capacity retention after the cycle characteristics test. It also makes clear that the Examples gives remarkably larger output characteristics value than that of the Comparative Examples, and good discharge capacities.

### INDUSTRIAL APPLICABILITY

The battery including the electrolytic solution of the present disclosure can be utilized as various power sources such as power sources for portable devices and power sources for vehicles.

1. A lithium-sulfur secondary battery comprising a positive electrode or a negative electrode containing a sulfur-containing electrode active material containing at least one selected from the group consisting of simple sulfur, lithium polysulfides (Li₂Sn: 1≤n≤8) and organosulfur compounds, wherein the lithium-sulfur secondary battery comprises an electrolytic solution comprising:
a fluorinated ether represented by formula (1):
Rf-(OR¹)ₙ—O—R²
wherein Rf is an alkyl group having a fluorine atom and optionally forming a branch or a ring having 1 to 5 carbon atoms; R¹ is an alkyl group optionally having a fluorine atom; R² is an alkyl group having no fluorine atom, having 1 to 9 carbon atoms and optionally forming a branch or a ring; n is 0, 1 or 2; and the number of carbon atoms in one molecule is 5 or more;
an ether compound represented by formula (2):
R⁴—(OCHR³CH₂)ₓ—OR⁵
wherein R⁴ and R⁵ are each independently selected from the group consisting of alkyl groups having 1 to 9 carbon atoms and having no fluorine atom, a phenyl group optionally substituted by a halogen atom and a cyclohexyl group optionally substituted by a halogen atom, and optionally together form a ring; R³ each independently represent H or CH₃; and x represents 0 to 10; and an alkali metal salt,
wherein the fluorinated ether represented by the formula (1) and the ether compound represented by the formula (2) in total is 80% by weight or more of a solvent in the electrolytic solution.

2. The lithium-sulfur secondary battery according to claim 1, wherein the fluorinated ether is at least one selected from the group consisting of HCF₂CF₂OCH₂CH₂CH₃, HCF₂CF₂OCH₂CH₂CH₂CH₃, HCF₂CF₂CH₂OCH₂CH₃, HCF₂CF₂CH₂OCH₂CH₂CH₃, HCF₂CF₂CH₂OCH₂CH₂CH₂CH₃, CF₃CHFCF₂OCH₂CH₃ and CF₃CHFCF₂OCH₂CH₂CH₃.

3. The lithium-sulfur secondary battery according to claim 1, wherein the ether compound is at least one selected from the group consisting of tetrahydrofuran (THF), 1,3-dioxolane, 1,4-dioxane, glymes, and derivatives thereof.

4. The lithium-sulfur secondary battery according to claim 1, wherein the alkali metal salt is represented by LiX; and
X is at least one selected from the group consisting of Cl, Br, I, BF₄, PF₆, CF₃SO₃, ClO₄, CF₃CO₂, AsF₆, SbF₆, AlCl₄, bistrifluoromethanesulfonylamide (TFSA), N(CF₃SO₂)₂, N(CF₃CF₂SO₂)₂, PF₃(C₂F₅)₃, N(FSO₂)₂, N(FSO₂) (CF₃SO₂), N(CF₃CF₂SO₂)₂, N(C₂F₄S₂O₄), N(C₃F₆S₂O₄), N(CN)₂, N(CF₃SO₂) (CF₃CO), R⁶FBF₃ wherein R⁶F is n-CₘF₂ₘ₊₁ and m is a natural number of 1 to 4, and R7BF3 wherein R⁷ is n-CₚH₂ₚ₊₁ and p is a natural number of 1 to 5.

5. The lithium-sulfur secondary battery according to claim 1, comprising a positive electrode containing a sulfur-containing electrode active material.

6. A module, comprising the lithium-sulfur secondary battery according to claim 1.
